(19) United States
(12) Patent Application Publication
(10) Pub. No.: US 2015/0264095 A1
(43) Pub. Date: Sep. 17, 2015

(54) WEB SERVICE PUSH METHOD AND WEB SERVICE PUSH SERVER AND WEB SERVICE PROVIDING SERVER PERFORMING SAME

(71) Applicant: NABLE COMMUNICATIONS, INC., Seongnam-si, Gyeonggi-do (KR)

(72) Inventors: Dae-Young Kim, Seoul (KR); Hye-Young Kim, Seoul (KR); Myeong Chang Kang, Seongnam-si (KR)

(21) Appl. No.: 14/433,294

(22) PCT Filed: Jan. 13, 2014
(86) PCT No.: PCT/KR2014/000341

§ 371 Date: Apr. 2, 2015

(30) Foreign Application Priority Data
Jan. 15, 2013 (KR) 10-2013-0004637

(51) Int. Cl. H04L 29/06; H04L 29/08

(52) U.S. Cl. CPC H04L 65/4061; H04L 67/02; H04L 67/42; H04L 67/04

(57) ABSTRACT

A web service push method is performed by a web service push server connected to a web service providing server, a push server, and a user terminal capable of executing a web browser and including a push client. The web service push method includes the steps of: receiving, from the web service providing server, push request information including a location identifier of a web service and a web browser identifier; determining a push identifier relating to the web browser based on the received web browser identifier; generating a web service push message including the location identifier and the determined push identifier; and transmitting the generated web service push message to the push server to enable the user terminal to receive the web service through the web browser.

### TECHNICAL FIELD

The present invention relates to a web service pushing technology, and more particularly, to a technology that may provide a web service even when a user terminal does not execute a web browser, in turn allowing a user terminal to access a web application or a webpage relating to the web service, use a web service push server that receives a web browser identifier and a location identifier for a web service from a web service provider server, determine a push identifier associated with a web browser identifier stored in advance, and push a location identifier allowing a web browser associated with the push identifier to receive a web service through a push server.

### BACKGROUND ART

Web browsers, for example, Internet Explorer, Safari, and Chrome, have a function of accessing a web server, receiving needed code, and outputting the received code through a Uniform Resource Locator (URL). With the recent advent of HTML5 and WebRTC, web browsers may be used to provide a web service such as Voice Over Internet Protocol (VoIP), in addition to displaying a webpage.

Under these circumstances, user terminals such as smart phones receive desired web services by executing web applications associated with the web services or using web browsers capable of displaying webpages. However, when the user terminals do not execute the web browsers, the web services may not be provided.

At present, various technologies that may push web services to mobile terminals are available. The following patents disclose related technologies.

Korean Patent Application Publication No. 10-2010-0000576 relates to a system for supporting a mobile push service and a method thereof. In detail, the system includes a service server that, when requested to push a message corresponding to a predetermined advertisement, calculates an advertising effect model based on at least one piece of user response information collected in advance for at least one advertisement type, and determines an advertising time corresponding to a pertinent advertisement type in accordance with the calculated advertising effect model, and a message center that transmits a push message corresponding to the advertisement to a user terminal in accordance with the determined advertisement time. Further, the method includes calculating an advertising effect model based on at least one piece of user response information collected in advance for at least one advertisement type, when receiving a request for transmitting a push message corresponding to a predetermined advertisement, by means of a service server, determining the advertising time corresponding to a pertinent advertisement in accordance with the calculated advertising effect model, by means of the service server, and transmitting a push message corresponding to the advertisement to a mobile terminal in accordance with the determined advertising time by means of a message center. Accordingly, this patent may maximize the advertising effect and further satisfy users.

Korean Patent Application Publication No, 10-2009-0101055 relates to a system for managing a multi-service of pushing contents through a wireless network. In detail, the system includes a content receiver unit that receives contents from application service providers, a series handler unit that secures transmission of contents in a predetermined order by the application service providers, a group handler unit that enables the application service providers to define groups, search the members in the groups, and push the contents to the members in the groups, a plurality of content transmitters that transmit content data to client terminals, and a content transmitter unit that stores a list of the content transmitters, enqueues the contents in the content transmitters, and activates the content transmitters, in which the content transmitters each including a queuer that verifies urgency levels of the contents, customer levels of the client devices, and a policy for dequeuing the contents, a plurality of queues that support various priority levels, a dequeuer that manages the queues based on a scheduling algorithm for preventing starvation of queues with lower priorities, and a network transmission unit that processes different transmission mechanisms for different client devices.

### DISCLOSURE OF INVENTION

### Technical Goals

The present invention provides a web service push method that may provide a web service even when a user terminal does not access a web browser, which allows a user terminal to access a web application or a webpage relating to the web service, by receiving a web browser identifier and a location identifier for a web service from a web service provider server, determining a push identifier associated with a web browser identifier stored in advance, and pushing a location identifier allowing for receiving a web service to a web browser associated with the push identifier through a push server, and a web service push server for the method.

The present invention provides a web service push method that may provide a web service even when a user terminal does not execute a web browser, which allows a user terminal to access a web application or a webpage relating to the web service, by creating push request information including a web browser identifier and a location identifier for a web service in a web service push server, transmitting the push request information to the web service push server, and making the web service push server push the location identifier to a web browser corresponding to the web browser identifier through a push server, and a web service provider server for the method.

### Technical Solutions

According to an aspect of the present invention, there is provided a web service push method performed in a web service push server capable of executing a web browser and connected with a user terminal including a push client, a push sever, and a web service provider server. The web service push method includes receiving push request information including a web browser identifier and a location identifier for a web service from the web service provider server, determining a push identifier associated with the web browser based on the received web browser identifier, creating a web service push message including the determined push identifier and the location identifier; and allowing the user terminal to receive the web service through the web browser by transmitting the created web service push message to the push server.

The receiving of push request information may further include verify valid reception of the push request information by receiving at least one of a predetermined web service identifier and an authentication token issued in advance from the web service provider server.

The receiving of push request information may further include receiving, as the location identifier, a web application or a Uniform Resource Locator (URL) for a webpage associated with the web service.

The web service push method may further include receiving, from a web browser in the user terminal, a push identifier issued by the push sever and the web browser identifier in advance, matching the push identifier and the web browser identifier, and storing the matched identifiers in an identifier database.

The determining of a push identifier associated with the web browser may further include requesting, based on the received web browser identifier, information on the identifier database from the push identifier.

The creating of a web service push message may further include receiving at least one of a text message to be displayed when the user terminal receives the location identifier from the web service provider server and post data to be transmitted when the location identifier is opened in a post type, and then disposing one of the text message and the post data into the web service push message.

The allowing of the user terminal to receive the web service through the web browser may further include commanding the push server to transmit the location identifier to a web browser associated with the push identifier.

According to another aspect of the present invention, there is provided a web service push method that is performed in a web service provider server capable of executing a web browser and connected with a web service push server and a user terminal including a push client. The web service push method includes creating push request information including a web browser identifier and a location identifier for a web service, and commanding the web service push server to transmit the location identifier to the web browser through a push server associated with the push client by transmitting the created push request information to the web service push server.

The web service push method may further include receiving a user identifier and the web browser identifier in advance from a web application executed on the web browser, and matching and storing the user identifier and the web browser identifier.

The web service push method may further include providing a web application or a webpage of a web service associated with the location identifier in response to a request from the web browser.

According to another aspect of the present invention, there is provided a web service push method performed in a user terminal connected with a push server, a web service provider server, and a web service push server. The web service push method includes transmitting a push identifier and a web browser identifier issued by the push server to the web service push server, transmitting the web browser identifier and a user identifier to the web service provider server, and executing a web browser based on a location identifier for a web service pushed by the push server.

According to another aspect of the present invention, there is provided a web service push server that may execute a web browser and is connected with a user terminal, which includes a push client, a push sever, and a web service provider server. The web service push server includes a push request information receiver that receives push request information including a web browser identifier and a location identifier for a web service from the web service provider server, a push identifier determiner that determines a push identifier associated with the web browser based on the received web browser identifier, a push message creator that creates a web service push message including the determined push identifier and the location identifier, and a push message transmitter that makes the user terminal receive the web service through the web browser by transmitting the created web service push message to the push server.

The push request information receiver may verify valid reception of the push request information by receiving, from the web service provider server, at least one of a predetermined web service identifier and an authentication token issued in advance.

The push request information receiver may receive, as the location identifier, a web application or a Uniform Resource Locator (URL) for a webpage associated with the web service.

The push identifier determiner may receive in advance a push identifier issued by the push server and the web browser identifier from a web browser in the user terminal, match the push identifier and the web browser identifier, and store the matched identifiers in an identifier database.

The push identifier determiner may request, based on the received web browser identifier, information on the push identifier from the identifier database.

The push message creator may receive, from the web service provider server, at least one of a text message to be displayed when the user terminal receives the location identifier and post data to be transmitted when the location identifier is opened in a post type, and then dispose of the text message and the post data into the web service push message.

The push message transmitter may command the push server to transmit the location identifier to a web browser associated with the push identifier.

According to another aspect of the present invention, there is provided a web service provider server that may execute a web browser and is connected with a web service push server and a user terminal including a push client. The web service provider server includes a push request information creator that creates push request information including a web browser identifier and a location identifier for a web service, and a push request information transmitter that commands the web service push server transmit the location identifier to the web browser through a push server associated with the push client by transmitting the created push request information to the web service push server.

According to another aspect of the present invention, there is provided a user terminal connected with a push server, a web service provider server, and a web service push server and performs a web service push method. The user terminal includes a web browser that receives a push identifier issued from the push server through a push client in the user terminal, transmits the push identifier to the web service push server, and registers a web browser identifier on the web service push server, in which the web browser may execute a web application that transmits a user identifier and the web browser identifier to the web service provider server, and receive a location identifier associated with a web service from the push server through the push client.

### Effects of the Invention

A web service push method according to an embodiment of the present invention and related technologies may provide a web service even when a user terminal does not execute a web browser, which allows a user terminal to access a web application or a webpage related to the web service, using a web service push server that receives a web browser identifier and a location identifier for a web service from a web service provider server, determines a push identifier associated with a web browser identifier kept in advance, and pushes a location identifier allowing for receiving a web service to a web browser associated with the push identifier through a push server.

The present invention provides a web service push method according to an embodiment of the present invention and related technologies may provide a web service even when a user terminal does not execute a web browser, which allows a user terminal to access a web application or a webpage related to the web service, by creating push request information including a web browser identifier and a location identifier for a web service in a web service push server, transmitting the push request information to the web service push server, and commanding the web service push server push the location identifier to a web browser corresponding to the web browser identifier through a push server.

### BRIEF DESCRIPTION OF DRAWINGS

FIG. 1 is a diagram illustrating a web service push system according to the present invention.

FIG. 2 is a block diagram illustrating the user terminal illustrated in FIG. 1.

FIG. 3 is a block diagram illustrating a web service provider server illustrated in FIG. 1.

FIG. 4 is a block diagram illustrating the web service push server illustrated in FIG. 1.

FIG. 5 is a flowchart illustrating a web service push method performed by a web service push server according to the present invention.

FIG. 6 is a flowchart illustrating a web service push method performed by a web service push system according to an embodiment of the present invention.

### BEST MODE FOR CARRYING OUT THE INVENTION

The description of the present invention provides just examples for structural and functional illustration, and thus the scope of the present invention should not be construed as being limited by these examples. That is, since the present invention may be variously modified and have several exemplary embodiments, the scope of the present invention should be understood as including equivalents by which the spirit of the present invention may be achieved. Further, the objects or effects proposed herein do not mean that specific embodiments are supposed to including all of them or only the effects, so the scope of the present invention should not be construed as being limited thereto.

The terms used herein should be understood as follows.

Terms, such as “first”, “second” etc, are for discriminating one component from another component, but the scope is not limited to the terms. For example, the first component may be named the second component and the second component may also be similarly named the first component.

It should be understood that when one element is referred to as being “connected to” another element, it may be connected directly to another element or be connected to another element, having the other element intervening therebetween. On the other hand, it should be understood that when one element is referred to as being “connected directly to” another element, it may be connected to another element without the other element intervening therebetween. Further, other expressions describing the relationships of components, that is, “between” and “directly between”, or “close to” and “directly close to” should be understood in the same way.

Singular forms are intended to include plural forms unless the context clearly indicates otherwise. It will be further understood that the terms “comprises” or “have” as used in this specification specify the presence of stated features, steps, operations, components, parts, or a combination thereof, but do not preclude the presence or addition of one or more other features, numerals, steps, operations, components, parts, or a combination thereof.

The reference characters (for example, a, b, and c) used in the steps are used for the convenience of illustrating, and they do not mean the order of the steps and the steps may be generated in different orders, unless the order is specifically stated. That is, the steps may be generated in the order described and substantially simultaneously, but they may be performed in reverse direction.

The present invention may be achieved as computer-readable codes on a computer-readable recording medium and the computer-readable recording medium includes all kinds of recording devices storing data that may be read by computer systems. The computer-readable recording medium may be ROM, RAM, CD-ROM, magnetic tape, a floppy disc, and an optical data storage, and may be implemented in a carrier wave type (for example, transmitted by the internet). The computer-readable recording mediums may be distributed to a computer system that is connected through a network and may store and execute computer-readable codes in the type of distribution.

Unless defined otherwise, it is to be understood that all the terms used herein including technical and scientific terms have the same meaning as those as understood by those who are skilled in the art. It should be understood that the terms defined by a dictionary must be identical with the meanings within the context of the related art, and they should not be ideally or excessively formally defined unless the context clearly dictates otherwise.

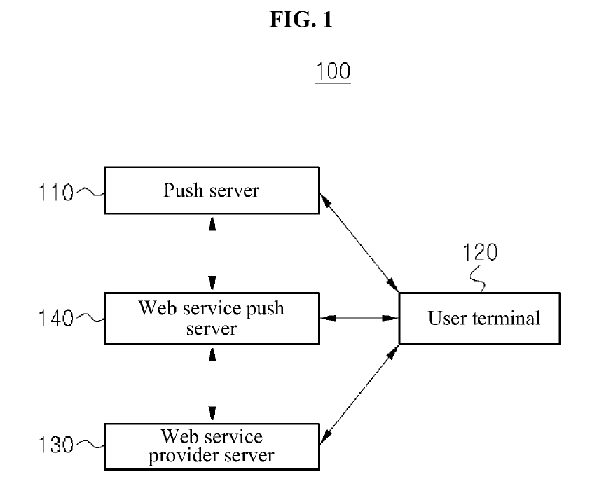

FIG. 1 is a diagram illustrating a web service push system according to the present invention.

Referring to FIG. 1, a web service push system 100 includes a push server 110, a user terminal 120, a web service provider server 130, and a web service push server 140.

The push server 110 is a computing device capable of transmitting specific data to push clients. For example, the push server 110 may be Apple Push Notification Service (APNS) server, a Google Cloud Messaging (GCM) server, or a South Korea Telecom (SKT) Smart Push server. The push server 110 gives push identifiers, for example, tokens, for specific applications in the user terminal 120, and when the push server 110 is requested to push specific data for a push identifier, the data may be transmitted to a push client.

The push server 110 may be connected with the user terminal 120 and the web service push server 140 through a network.

The user terminal 120 is a portable computing device including a push client. For example, the user terminal 120 may be a smart phone or a tablet Personal Computer (PC). In an embodiment, a push client 121 of the user terminal 120 may receive push identifiers for specific applications issued by the push server 110. The push identifiers may be unique tokens issued by the push server 110 for specific applications for example, a web browser, in the user terminal 120.

In an embodiment, a mobile OS may be installed in the user terminal 120. For example, an Apple operating system (iOS) or a Google Android operating system (OS) may be installed in the user terminal 120.

In an embodiment, the user terminal 120 may execute a web browser. For example, the web browser may be one of Internet Explorer, Safari, and Chrome. The user terminal 120 may execute a web application or output a webpage by executing the web browser.

The web service provider server 130 is a computing device providing web services. The web service provider server 130 may be managed by a web service company. For example, the web service provider server 130 may be a server that may be managed by an internet portal company, an internet calling service company, or an online game service company.

In an embodiment, the web service provider server 130 may provide a web service to the web browser 122 in the user terminal 120 through a web application or a webpage. In detail, when the user terminal 120 executes a web application or calls a webpage from which the web application may be provided with a web service by executing the web browser 122, the web service provider server 130 may transmit the web service.

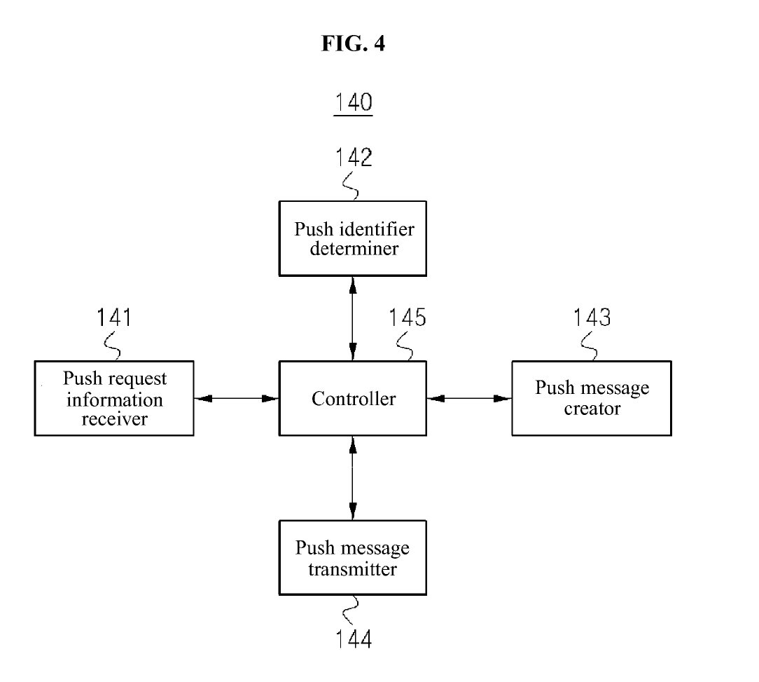

The web service push server 140 is a computing device that may be connected with the push server 110, the user terminal 120 and the web service provider server 130 through a network. The web service server 140 will be described in detail with reference to FIG. 4.

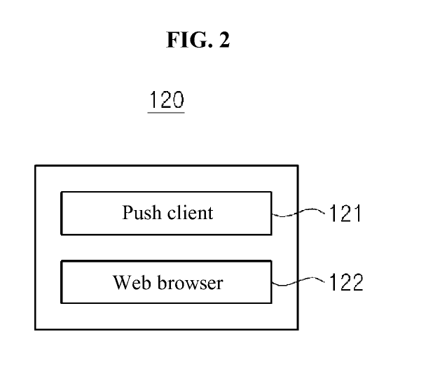

FIG. 2 is a block diagram illustrating the user terminal illustrated in FIG. 1.

Referring to FIG. 2, the user terminal 120 includes the push client 121 and the web browser 122.

The push client 121 is software included in the user terminal 120 and may transmit/receive specific data in cooperation with the push server 110.

In an embodiment, a push client 121 may receive push identifiers issued by the push server 110 for specific applications in the user terminal. The push identifiers may be eigenvalues, for example, tokens that may uniquely represent specific applications (web browser) in the specific user terminal 120.

The web browser 122 is software installed in the user terminal 120 and may execute web applications or output webpages. For example, the web browser 122 may be Internet Explorer, Safari, or Chrome. The web browser 122 may be configured for add-ons performing the functions associated with a web service push method to be described below.

In an embodiment, the web browser 122 may receive an issued push identifier through the push client 121 and transmit the push identifier to the web service push server 140.

In an embodiment, the web browser 122 may transmit a web browser identifier to the web service push server 140. The web browser identifier is an eigenvalue by which the web browser may be discriminated from web browsers in other user terminals. For example, the web browser identifier may be one of or a combination of a telephone number of the user terminal 120, an e-mail address, the identification (ID) of the user terminal 120, a push identifier of a web browser, and randomly created character strings.

For example, when the user terminal ID of an Android terminal named [Hong, Kil-Dong] is [android_kdhong], a web browser identifier for the web browser Chrome may be set as [kdhong@xxx.com/android_kdhong/chrome_v368] by combining an e-mail address [kdhong@xxx.com] of the user, the user terminal ID, and a browser identifier [chrome_v368].

Accordingly, the web browser identifier may be unique data used in the web service push server 140 in order to discriminate the web browser from web browsers in other user terminals in the process of performing a web service push method according to the present invention. In an embodiment, the web browser 122 may inquire as to whether an identical web browser identifier exists in the web service push server 140. That is, the web service push server 140 may assign a unique web browser identifier to each web browser 122.

In an embodiment, the web browser 122 may provide an API that may store the web browser identifiers and read the web browser identifiers from web applications or webpages executed by the web browser 122. A web application executed on the web browser 122 may include an identifier transmitter that transmits, to the web service provider server 130, known web browser identifiers as described above and user identifiers. For example, when a user joins a web service through a web application executed on the web browser 122, the web service provider server 130 may receive, match and store a user identifier for the user ID and the web browser identifier of the user terminal from the web application on the web browser 122.

In detail, for example, when a user logs-in to a web service through a web application executed on the web browser 122, alternatively, when a user logs-in to a previously joined web service or a first time web service, a user identifier and a web browser identifier may be transmitted to the web service provider server 130 through the web application (identifier transmitter) executed by the web browser 122.

In an embodiment, the web browser 122 may include an identifier transmitter that transmits push identifiers and web browser identifiers to the web service push server 140. The web service push server 140 may match and store push identifiers and web browser identifiers.

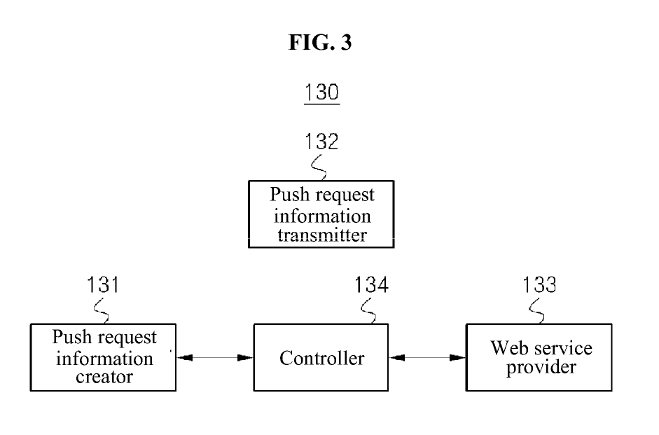

FIG. 3 is a block diagram illustrating a web service server illustrated in FIG. 1.

Referring to FIG. 3, the web service provider server 130 includes a push request information creator 131, a push request information transmitter 132, a web service provider 133, and a controller 134.

The push request information creator 131 creates push request information including web browser identifiers and location identifiers for web services. The location identifiers for web services may be web applications or a Uniform Resource Locator (URL) of webpages associated with the web services.

In detail, the push request information creator 131 may create push request information including a web browser identifier received from a web application on the web browser 122, a web application that may be connected with a web service, or a webpage URL.

The push request information transmitter 132 transmits push request information to the web service push server 140. The web service push server 140 receiving a push request information may determine a push identifier corresponding to a web browser identifier and transmit a location identifier for a web service to the web browser 122 through the push server 110.

In an embodiment, the push request information transmitter 132 may transmit at least one of a text message to be displayed when a user terminal receives a location identifier and post data to be transmitted when a location identifier is opened in a post type, to the web service push server 140.

For example, the push request information transmitter 132 may transmit data corresponding to [{WB_ID:01012345678}, {URL:rcs.xxx.com/Webclient}, {postdata:callID=01087654321&roomNumber=23142}, and {message: A request for sharing a video file has been received from Hong, Kil-Dong.}].

The web service provider 133 may provide a web application or a webpage for the web service associated with a location identifier in response to a request from the web browser 122. In detail, when the web browser 122 in the user terminal 120 receives a location identifier from the push server 110 through the push client 121, and then executes and requests a URL corresponding to the location identifier to the web service provider server 130, the web service provider 133 may provide a corresponding web application or a webpage to the web browser 122.

In an embodiment, the web service provider server 130 may include an identifier storage unit that receives a user identifier and a web browser identifier from a web application on the web browser 122, and match and store the user identifier and the web browser identifier. When the push request information creator 131 is required to provide a specific user with a web service, a determination may be made that a web browser identifier corresponds to a specific user identifier for example, a user ID, and create push request information including a location identifier for the web service.

The controller 134 controls the operation of the push request information creator 131, a push request information transmitter 132, and a web service provider 133, and the flow of data.

FIG. 4 is a block diagram illustrating the web service push server illustrated in FIG. 1.

Referring to FIG. 4, the web service push server 140 includes a push request information receiver 141, a push identifier determiner 142, a push message creator 143 a push message transmitter 144, and a controller 145.

The push request information receiver 141 receives push request information from the web service provider server 130. The push request information may include a web browser identifier and a location identifier for a web service.

In an embodiment, the push request information receiver 141 may verify valid reception of push request information. The push request information receiver 141 may verify valid reception of push request information by receiving at least one of a web service identifier set in advance and an authentication token issued in advance from the web service provider server 130.

For example, the push request information receiver 141 may assign a unique web service identifier for example, a web service domain and a password for the web service provider server 130 in advance. As another example, the push request information receiver 141 may issue an authentication token for the web service provider server 130 in advance. When push request information is received from the web service provider server 130, the push request information receiver 141 may receive and authenticate a web service identifier or an authentication token in order to examine reliability.

The push identifier determiner 142 determines a push identifier based on push request information received from the web service provider server 130. In detail, the push identifier determiner 142 may determine a push identifier corresponding to a web browser identifier in push request information.

In an embodiment, the push identifier determiner 142 may receive, from the web browser 122 in the user terminal 120, a push identifier and a web browser identifier issued by the push server 110 in advance. The push identifier determiner 142 may match and store push identifiers and web browser identifiers in an identifier database.

In an embodiment, the push identifier determiner 142 may determine a push identifier by requesting, from the identifier database, information on a push identifier associated with a web browser identifier in push request information. Here, the push identifier determiner 142 may construct, in advance, a database storing push identifiers and web browser identifier matched to a plurality of user terminals. When a request for pushing a specific web browser is received from the web service provider server 130, the push server may determine a push identifier for the web browser.

The push message creator 143 creates a web service push message. The web service push message may include a push identifier determined by the push identifier determiner 142 and a location identifier received by the push request information receiver 141.

In an embodiment, the push message creator 143 may receive at least one of a text message and post data from the web service provider server 130, and dispose the message and data into the web service push message.

The push message transmitter 144 may command the web browser 122 in the user terminal 120 to receive a web service by transmitting a web service push message to the push server 110.

In detail, the push message transmitter 144 may command the push server 110 to transmit the location identifier in the web service push message to a corresponding push client 121 by transmitting a web service push message to the push server 110. The push client 121 of the user terminal 120 may transmit the location identifier to the web browser 122 and the web service provider server 130 may provide a web application corresponding to the location identifier or a webpage in response to a request from the web browser 122.

That is, when the web browser 122 in the user terminal 120 is not executed, the web service provider server 130 may not provide a web service. However, the web service provider server 130 may provide a corresponding web service through the web service push server 140 and the push server 110, despite the web browser 122 in the user terminal 120 not being executed.

The controller 145 controls the operation of the push request information receiver 141, the push identifier determiner 142, the push message creator 143, and the push message transmitter 144, and the flow of data.

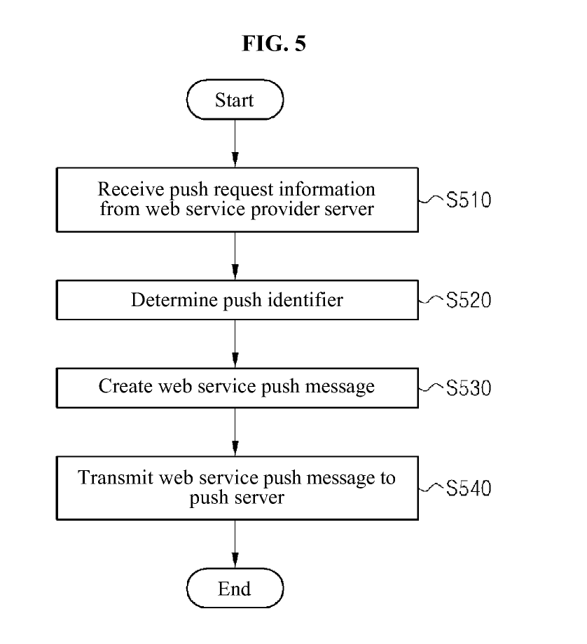

FIG. 5 is a flowchart illustrating a web service push method performed by a web service push server according to the present invention.

The push request information receiver 141 receives push request information from the web service provider server 130 in operation S510. The push request information may include a web browser identifier and a location identifier for a web service.

In an embodiment, the push request information receiver 141 may verify valid reception of push request information. The push request information receiver 141 may verify valid reception of push request information by receiving, from the web service provider server 130, at least one of a web service identifier set in advance and an authentication token issued in advance.

The push identifier determiner 142 determines a push identifier based on push request information received from the web service provider server 130 in operation S520. In detail, the push identifier determiner 142 may determine a push identifier corresponding to a web browser identifier in push request information.

In an embodiment, the push identifier determiner 142 may receive, match, and store a push identifier and a web browser identifier issued by the push server 110 from the web browser 122 in the user terminal 120.

In an embodiment, the push identifier determiner 142 may determine a push identifier required by the push server 110 to send a push message, by requesting, from the identifier database, information on a push identifier associated with a web browser identifier in push request information.

The push message creator 143 creates a web service push message in operation S530. The web service push message may include a push identifier determined by the push identifier determiner 142 and a location identifier received by the push request information receiver 141.

In an embodiment, the push message creator 143 may receive at least one of a text message and post data from the web service provider server 130 and put dispose the message and data into the web service push message.

The push message transmitter 144 transmits a web service push message to the push server 110 in operation S540.

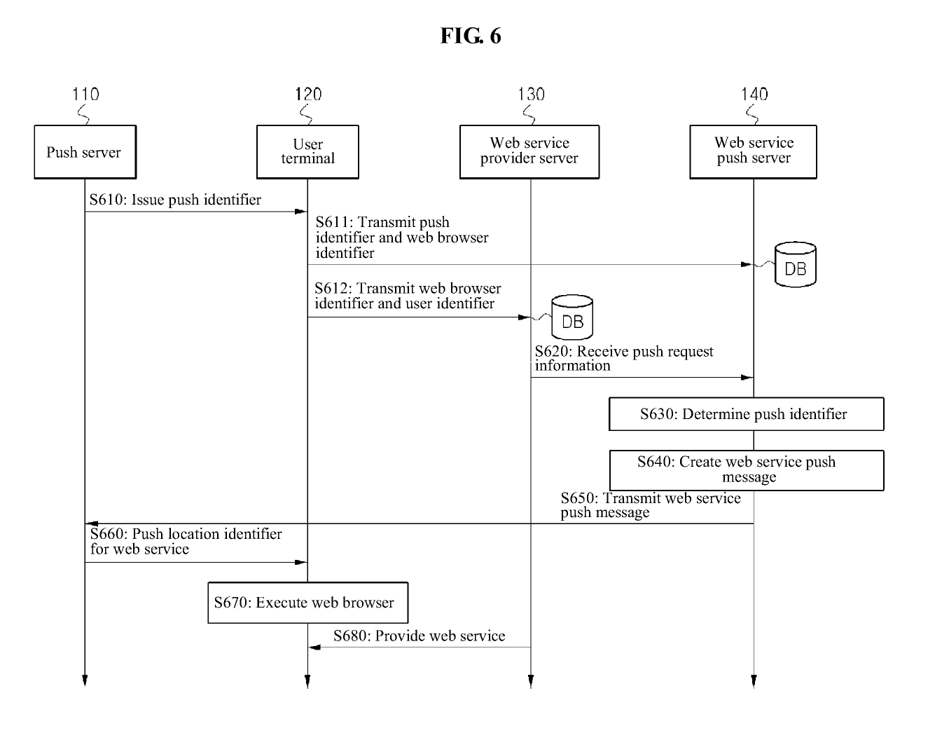

FIG. 6 is a flowchart illustrating a web service push method performed by a web service push system according to an embodiment of the present invention. In detail, FIG. 6 illustrates the flow of data among the components of the web service push system 100. Although it is assumed that a push identifier is a token and a web browser identifier is WB_ID, such an example is not intended to limit the scope of the present invention.

The push server 110 issues a token for the web browser 122 in the user terminal 120 in operation S610.

The web browser 122 in the user terminal 120 may transmit the token and WB_ID issued by the push sever 110 to the web service push server 140 in operation S611.

In an embodiment, the web service push server 140 may match tokens and WB_IDs received from web browsers 122 in a plurality of user terminals 120 and store the matched tokens and WB_IDs in the identifier database.

A web application executed on the web browser 122 in the user terminal 120 transmits WB_ID that is a web browser identifier and a user identifier (for example, user ID) to the web service provider server 130 in operation S612. The WB_ID may be unique data indicating a specific web browser 122 and used to discriminate the web browser 122 from other web browsers 122 in the web service push server 140.

In an embodiment, the identifier storage unit of the web service provider server 130 may match WB_IDs and user identifiers received from a plurality of user terminals 120 and store the matched WB_IDs and user identifiers in the identifier database.

When the web service provider server 130 intends to provide a specific user with a web service, the push request information creator 131 of the web service provider server 130 may search a WB_ID associated with a corresponding user identifier and create push request information including the searched WB_ID and the URL for the web service.

The push request information transmitter 132 of the web service provider server 130 may transmit the push request information to the web service push server 140 in operation S620.

The push identifier determiner 142 of the web service push sever 140 determines a push identifier based on push request information received from the web service provider server 130 in operation S630. The push identifier determiner 142 may determine a push identifier by requesting, from the identifier database, information on a token associated with the WB_ID in the push request information.

The push message creator 143 of the web service push server 140 creates a web service push message in operation S640. The web service push message may include a token determined by the push identifier determiner 142 and a URL received by the push request information receiver 141.

In an embodiment, the push message creator 143 may receive at least one of a text message and post data from the web service provider server 130 and dispose the text and data into the web service push message.

The push message transmitter 144 of the web service push server 140 transmits a web service push message to the push server 110 in operation S650.

The push server 110 transmits the URL for a web service to the web browser 122 corresponding to the token in the web service push message in operation S660.

The push client 121 of the user terminal 120 may receive the URL for the web service from the push server 110 and execute the web browser 122 by transmitting the URL for the web service to the web browser 122 in operation S670.

The web service provider 133 of the web service provider server 130 may provide a web application for the web service or a webpage in response to a request from the web browser 122 in operation S680.

Although a few embodiments of the present invention have been illustrated and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A web service push method performed in a web service push server executing a web browser and connected with a user terminal comprising a push client, a push sever, and a web service provider server, the method comprising:
receiving push request information comprising a web browser identifier and a location identifier for a web service from the web service provider server;
determining a push identifier associated with the web browser based on the received web browser identifier;
creating a web service push message comprising the determined push identifier and the location identifier; and
allowing the user terminal to receive the web service through the web browser by transmitting the created web service push message to the push server.

2. The method of claim 1, wherein the receiving of push request information further comprises verifying valid reception of the push request information by receiving at least one of a predetermined web service identifier and an authentication token issued in advance from the web service provider server.

3. The method of claim 1, wherein the receiving of push request information further comprises receiving, as the location identifier, a web application or a Uniform Resource Locator (URL) for a webpage associated with the web service.

4. The method of claim 1, further comprising:
receiving, from a web browser in the user terminal, a push identifier issued by the push sever and the web browser identifier in advance, matching the push identifier and the web browser identifier, and storing the matched identifiers in an identifier database.

5. The method of claim 4, wherein the determining of a push identifier associated with the web browser further comprises requesting, based on the received web browser identifier, information on the identifier database from the push identifier.

6. The method of claim 3, wherein the creating of a web service push message further comprises receiving at least one of a text message to be displayed when the user terminal receives the location identifier from the web service provider server and post data to be transmitted when the location identifier is opened in a post type, and then disposing one of the text message and the post data into the web service push message.

7. The method of claim 3, wherein the allowing of the user terminal to receive the web service through the web browser further comprises commanding the push server to transmit the location identifier to a web browser associated with the push identifier.

8. A web service push method performed in a web service provider server executing a web browser and connected with a web service push server and a user terminal comprising a push client, the method comprising:
creating push request information comprising a web browser identifier and a location identifier for a web service; and
commanding the web service push server to transmit the location identifier to the web browser through a push server associated with the push client by transmitting the created push request information to the web service push server.

9. The method of claim 8, wherein the creating of push request information further comprises receiving a user identifier and the web browser identifier in advance from a web application executed on the web browser, and matching and storing the user identifier and the web browser identifier.

10. The method of claim 8, further comprising:
providing a web application or a webpage of a web service associated with the location identifier in response to a request from the web browser.

11. A web service push method performed in a user terminal connected with a push server, a web service provider server, and a web service push server, the method comprising:
transmitting a push identifier and a web browser identifier issued by the push server to the web service push server;
transmitting the web browser identifier and a user identifier to the web service provider server; and
executing a web browser based on a location identifier for a web service pushed by the push server.

12. A web service push server that executes a web browser and is connected with a user terminal comprising a push client, a push sever, and a web service provider server, the web service push server comprising:
a push request information receiver to receive push request information comprising a web browser identifier and a location identifier for a web service from the web service provider server;
a push identifier determiner to determine a push identifier associated with the web browser based on the received web browser identifier;
a push message creator to create a web service push message comprising the determined push identifier and the location identifier; and
a push message transmitter to allow the user terminal to receive the web service through the web browser by transmitting the created web service push message to the push server.

13. The web service push server of claim 12, wherein the push request information receiver verifies valid reception of the push request information by receiving, from the web service provider server, at least one of a predetermined web service identifier and an authentication token issued in advance.

14. The web service push server of claim 12, wherein the push request information receiver receives a web application or a Uniform Resource Locator (URL) for a webpage, associated with the web service, as the location identifier.

15. The web service push server of claim 12, wherein the push identifier determiner receives in advance a push identifier issued by the push server and the web browser identifier from a web browser in the user terminal, matches the push identifier and the web browser identifier, and stores the matched identifiers in an identifier database.

16. The web service push server of claim 15, wherein the push identifier determiner requests, based on the received web browser identifier, information on the push identifier from the identifier database.

17. The web service push server of claim 14, wherein the push message creator receives, from the web service provider server, at least one of a text message to be displayed when the user terminal receives the location identifier and posts data to be transmitted when the location identifier is opened in a post type, and then disposes one of the text message and the post data into the web service push message.

18. The web service push server of claim 14, wherein the push message transmitter commands the push server to transmit the location identifier to a web browser associated with the push identifier.

19. A web service provider server that executes a web browser and is connected with a web service push server and a user terminal comprising a push client, the web service provider server comprising:
a push request information creator to create push request information including a web browser identifier and a location identifier for a web service; and
a push request information transmitter to command the web service push server transmit the location identifier to the web browser through a push server associated with the push client by transmitting the created push request information to the web service push server.

20. A user terminal connected with a push server, a web service provider server, and a web service push server and performs a web service push method, the user terminal comprising:
a web browser to receive, from the push server, a push identifier issued through a push client in the user terminal, transmit the push identifier to the web service push server, and register a web browser identifier on the web service push server,
wherein the web browser executes a web application that transmits a user identifier and the web browser identifier to the web service provider server, and receives a location identifier associated with a web service from the push server through the push client.
